(19) United States
(12) Patent Application Publication
(10) Pub. No.: US 2003/0121057 A1
(43) Pub. Date: Jun. 26, 2003

(54) Script-based method for unattended control and feature extensions of a TV or settop box device

(75) Inventor: Kenneth Sugrim Singh, Harriman, NY (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V., Eindhoven (NL)

(21) Appl. No.: 10/028,574

(22) Filed: Dec. 20, 2001

(51) Int. Cl. H04N 7/173

(52) U.S. Cl. 725/132

(57) ABSTRACT

A shell is provided within a video receiver for running at least one script controlling the channel(s) to which the video receiver is tuned during associated periods for display, recording, or both of selected broadcast programming. The scripts are structured to select content based on user-specified descriptive criteria such as title or description keyword, together with associated user-defined priorities, applied in cases of multiple concurrent matches, and user-defined conditions regarding existing viewing of other content, viewer identity, or the like. Scripts may be generated by the viewer or transmitted to the video receiver from an external source for selective execution by the user. Control extension and customization over the video receiver is thus provided without replacement of the firmware or portions thereof.

### TECHNICAL FIELD OF THE INVENTION

The present invention is directed, in general, to customized control over operation of video receivers and, more specifically, to unattended script-based viewer-selected customization for control over operation of video receivers.

### BACKGROUND OF THE INVENTION

Typically televisions, settop boxes, and other video receivers are operated utilizing the control features provided by the firmware within the device during manufacture. Recently, upgrades to the control software within such a device via the network to which the device is connected have also been possible, but only by replacing the entire internal firmware or portions thereof.

In addition, increasing viewer sophistication and integration of Web browsing and other text-driven applications into the broadcast television environment drives a need for meaningful customization of a video receiver's control features using simple, non-invasive mechanisms within the viewer's home.

There is, therefore, a need in the art for providing customization over unattended control of video receivers.

### SUMMARY OF THE INVENTION

To address the above-discussed deficiencies of the prior art, it is a primary object of the present invention to provide, for use in video receiver, a shell within the video receiver for running at least one script controlling the primitive operations of a video receiver such as, for example, the channel(s) to which the video receiver is tuned during associated periods for display, recording, or both of selected broadcast programming. The primitive operations of the video receiver are provided in an Application Programming Interface (API) supplied with the video receiver as part of the firmware of the video receiver. Scripts are structured to select content based on user-specified descriptive criteria such as title or description keyword, together with associated user-defined priorities, applied in cases of multiple concurrent matches, and user-defined conditions regarding existing viewing of other content, viewer identity, or the like. Scripts may be generated by the viewer or transmitted to the video receiver from an external source for selective execution by the user. Control extension and customization over the video receiver is thus provided without replacement of the firmware or portions thereof.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a video receiver including script-based viewer control according to one embodiment of the present invention; and

FIGS. 2A and 2B are a high level flow chart for a process of script-based viewer control of a video receiver according to one embodiment of the present invention.

### DETAILED DESCRIPTION OF THE INVENTION

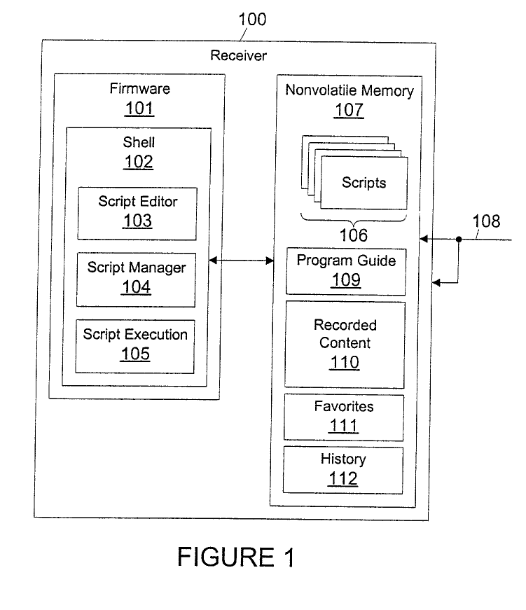

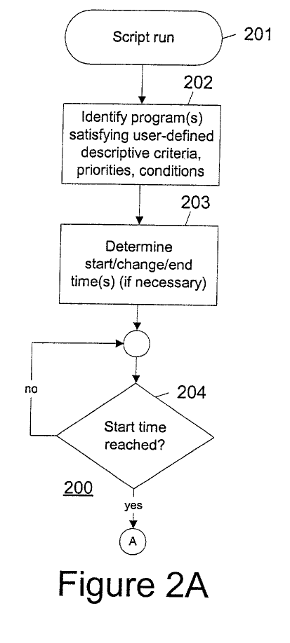

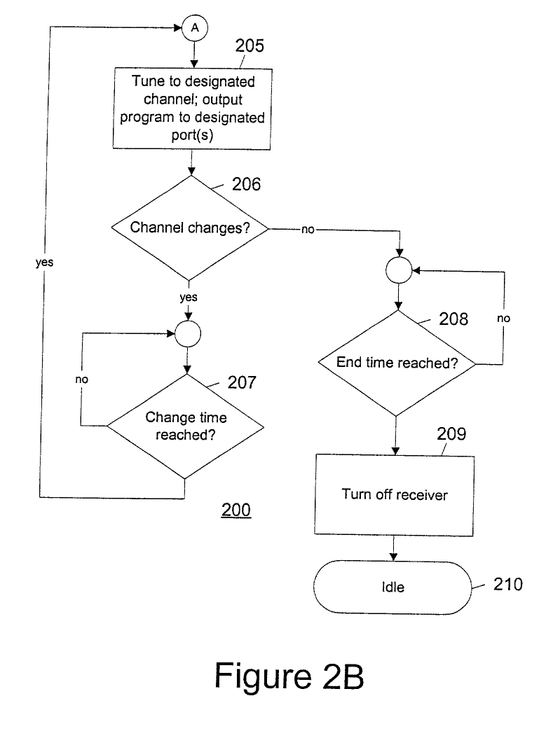

FIGS. 1 and 2A-2B, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a block diagram for a video receiver including script-based viewer control according to one embodiment of the present invention. Video receiver 100 is a television, settop box, or digital video cable, satellite or terrestrial broadcast receiver. Those skilled in the art will recognize that the entire construction and operation of a video receiver is not depicted or described herein. However, the present invention may be employed in conjunction with conventional video receivers, and only so much of the video receiver construction and operation as is necessary for an understanding of or unique to the present invention is depicted and described herein.

Video receiver 100 includes firmware 101, a combination of hardware and software defining operation and control of video receiver 100. In the present invention, firmware 101 includes an interactive program (“Shell”) 102 employed to create and run scripts, text-based sequences of instructions or commands for controlling operation of the video receiver 100. Shell 102 thus includes a script editor 103 for editing the contents of a script, a script manager 104 for creating, deleting, or scheduling execution of a script, and a script execution module 105 for executing scripts.

Scripts 106 for controlling operation of video receiver 100 are stored within a nonvolatile memory 107 (e.g., a flash memory or a magnetic disk) contained within or coupled to video receiver 100. Scripts 106 control timing and selection of channels or broadcast content which is demodulated by video receiver 100 for display and/or output to other devices such as a video cassette recorder (not shown).

Scripts 106 may be created by the viewer or transmitted to video receiver 100 via an input 108 at which video information is received. That is, scripts 106 may be generated remotely and transmitted to video receiver 100 utilizing the same broadcast medium (e.g., cable, satellite or terrestrial broadcast or Internet streaming) as the video programming to be demodulated and displayed. Scripts 106 provided from external sources may be complete or “templates” used by the viewer to create one or more complete scripts by addition of content for appropriate fields (e.g., time or channel).

Scripts 106 may be utilized to create macro operations combining fundamental operations of the video receiver 100. For instance, a simple form of script may select the channel or program to be demodulated and displayed during selected periods, with channel or program changes occurring at preselected times within the overall period encompassed by the script. This may be useful, for example, in programming the video receiver 100 to automatically select a morning lineup of a toddler's favorite programs for display, where some programs are on different channels than others. The toddler's parent need not manually navigate the lineup (i.e., need not manually change programs at appropriate times). Other script-directed broadcast programming view may include, for a television including picture-in-picture (PIP) capabilities, periodic cycling within the inset of the current programming on a series of selected channels.

A script may also be utilized to allow recording of specific content from a particular channel received by digital cable or satellite broadcast utilizing a standard analog video cassette recorder (VCR). The user may wish to record content on a regular basis—say, a soap opera airing weekdays on a particular channel at a particular time. Video receiver 100 may be programmed by a script to demodulate the appropriate channel during the appropriate period and output the program, properly formatted for recording by the VCR, to a rear panel output jack to which the VCR is connected (with or without concurrently displaying the program). Since the analog VCR does not include a digital tuner, the VCR need only be set to record channel 3 or 4 (for instance) at the proper time. If the video receiver 100 is capable of controlling the VCR (e.g., by emulating an infrared remote control for the VCR) the VCR need not even be separately programmed. Instead, control over the VCR by the video receiver 100 may be included within the script.

Rather than based strictly on channel and start/end times, script-based control over operation of video receiver 100 may be keyed to specific program content. For example, program guide information 109, describing the program content broadcast on each channel during relevant periods, may be received by video receiver 100 over input 108 together with program content. Program guide information 109 may be stored within memory 107 and periodically updated by retrieval of more current information by video receiver 100.

Scripts may be created to search for and record particular programs by descriptive criteria such as title (e.g., “The Sopranos”) or keywords within the associated description (e.g., “Western” or “John Wayne”) within the program guide information 109, independent of the channel and time during which the program is aired. Scripts may be programmed to determine, from the description, whether a particular episode or movie has already been recorded, and record only programs which have not been previously recorded. For this purpose, the scripts 106 may include internal flags set once a program has been recorded, or may store program guide information associated with recorded programs with the recorded content for later comparison with program guide information for programming currently being broadcast.

For broadcast programs including commercials, scripts may be programmed to record programs with special handling of commercials, such as skipping all commercials or skipping commercials except those accompanied by sale information (e.g., electronic coupons) sent along as private data, either with the program content or via another communications channel. By buffering content and using closed captioning information associated with broadcast programming or image detection for specific content within broadcast programming, a script may also be programmed to monitor content broadcast on one or more channels (e.g., all major network channels) and record commercials for a particular product (e.g., Budweiser commercials). Such use of closed captioning information and image detection may also be employed by scripts in selecting base program content for recording.

If the nonvolatile memory 107 within video receiver 100 is a hard disk drive, selected broadcast programming may be transmitted to a portion 110 of the hard disk drive 107 rather than to an external recording device such as a VCR. The introduction of hard disk drives into digital video appliances such as television receivers and settop boxes expands the potential of script-based control. Users may customize not only what is recorded, but also how. For instance, a script may include parameters controlling tradeoffs between recording time, picture quality, and space available within the hard disk. A connection (not shown) such as a universal serial bus (USB or 1394) port within video receiver 100 may allow recorded content 110 to be exported to an external device, such as a read-write digital versatile disk (R-W DVD) unit or a personal computer. Shell 102 may also allow a user to manage the contents of recorded content 110 by deleting or exporting selected items.

It should be noted that script execution for the purposes of recording selected broadcast programming, regardless of whether to an internal or external recording device, may run in the background while the user views other broadcast programming on a display for the video receiver 100. The receiver 100 in this case can contain multiple tuners (not shown in the figure).

Access to the scripting utilities 103-105 by the user may be through a button on a front panel of video receiver 100 or on a remote control associated with video receiver 100, or within a menu for controlling video receiver 100. The lexicon and associated syntax for the script language should preferably be simple and taken from everyday terms with which the viewer is likely to be familiar. Script display to the user may be text based or graphical.

Script-based control over a video receiver 100 allows a viewer to customize the operations of the video receiver 100 to suit personal viewing needs, extending or effectively customizing the control and operation of the video receiver 100 without the need for remote upgrade of several megabytes of control software within the video receiver 100. Script-directed viewing or recording of broadcast programming content is likely to be attractive to sophisticated viewers, particularly for viewers employing Web browsing or other applications in conjunction with broadcast programming.

An important feature of the present invention is the ability of video receiver 100, under control of a script, to select from among multiple alternative user-designated programs for display and/or recording based on user-defined priorities. For instance, in the example involving a toddler described above, the parent may program a morning line-up including a program on the Public Broadcasting System (PBS). Aware of periodic preemption of regular programming on that network for fund raisers, however, the parent may select an alternative program at the time of script creation. During execution of the script, video receiver 100 determines whether the programming on the designated channel at the designated time includes designated keyword(s) (e.g., “Sesame Street”) within the program guide information description. If so, the tuner is set to display the “primary” designated by the script; otherwise the tuner is set to display the alternative program. Similar prioritized alternative-based control may be employed, for example, for sports or special programming preemption of prime-time broadcast programming, or broadcasting of “reruns.”

Another example of user-defined alternatives and priorities involves use of a ranked “favorites” list 111 defined by the user, either independently created or automatically extrapolated and/or user-edited from a viewing history 112 of the subscriber's recently viewed programs. Available programming on a set of channels is periodically checked (e.g., each time the program guide information 109 is updated) by an executing script, with either channels containing matches being automatically selected for display or a message regarding the availability of the matching program content being displayed to the user. This allows a user to automatically track network program shuffling or multiple airings during a single week of a particular program.

Viewing history 112, which identifies programming content during a given period (e.g., last sixty days) that has already been displayed and/or recorded may also be employed in selecting among alternatives. For example, the user may set a script to monitor for airings of “Band of Brothers” on any Home Box Office (HBO) channel, but only display (or notify the user of) a current airing if the episode has not been previously viewed or recorded.

Alternative-based control of the operation of video receiver 100 need not be limited to prioritized selection from concurrently airing program content for display and/or recording. Conditional alternatives set by a user at the time of script creation through scripting may include display versus recording, dependent upon selected conditions. For example, if user-selected content (e.g., from the favorites list 111) is identified as being aired on a particular channel, the script may determine whether the user is currently viewing other content (e.g., by determining whether the video receiver is “on” or active, and/or whether the channel settings for video receiver have remained constant over a given period or been changed by a user “channel surfing” available content). If the user is currently viewing other content, the matching content may be automatically recorded rather than displayed, and/or display of a message to the user relating to the matching content may be displayed or delayed until a next commercial break.

Finally, alternative-based control allows a script (or multiple scripts operating in conjunction) to select content for display based on an identification of the current viewer. Many video systems allow designation of the viewer (e.g., “Family”, “Dad”, etc.) to control channel access, display preferences, or other variables. Such designations may be similarly employed as a condition to automatically select content for display, choosing content preferred by or appropriate for the current designated viewer.

FIGS. 2A and 2B are a high level flow chart for a process of script-based viewer control of a video receiver according to one embodiment of the present invention. The process 200 begins with running of a script within a video receiver being initiated by a user (step 201). The user may manually initiate running of a selected script by pressing a button or selecting a “Run” menu option while viewing or editing the script, or the script may automatically be run in response to the user generating the script and then exiting the scripting function.

In the exemplary embodiment involving description-based selection of programs, each executing script first identifies (step 202) programs matching user-specified descriptive criteria such a title or description keyword, together with user-defined priorities (if multiple matches are identified) and conditions (e.g., other content currently being viewed or matching content inappropriate for current viewer). Such identification may be made prospectively from program guide information for upcoming programming (e.g., the script may execute every hour and check programming for the next two hours). As indicated, selection of content may involve resolution of priorities between concurrently airing programs each matching different user-specified descriptive criteria, or conditions such as current viewing of other content or viewer identity.

Start, change or changes, and end times for the script are first determined (step 203), if necessary. That is, if the script selects programming for display or recording based on content (e.g., title, description keywords, etc.) rather than on channel and start/end times, the appropriate start, change and end times are determined from, for example, program guide information. For scripts continuously or periodically checking for particular content, determination of start, change and end times may be prospective.

The current time (including day and/or date) is then monitored to determine when the start time of at least some content matching the user specified descriptive criteria has been reached (step 204). Once the start time is reached, the receiver is tuned to the designated channel and the program is demodulated and output to the designated port(s) (step 205). The program may be output to a display for the video receiver, to an internal recording device, to a connection to an external recording device, or to some combination of the three. Alternatively, under certain user-defined conditions (e.g., current viewing of other content), the viewer may be simply notified of the matching content by a display message rather than changing the channel displayed on the receiver, and/or a picture-in-picture window may be opened to display the matching content with a message.

A determination is then made regarding whether any channel changes are required by the script prior to the script end time (step 206). If so, the current time is monitored to determine when the next change time has been reached (step 207), and the receiver is tuned to the new channel, with the program being output to whichever port(s) are designated for the relevant portion of the script period (step 205).

Once all intermediate change changes have been performed, however, the current time is monitored to determine whether the script end time has been reached (step 208). Once the end time is reached, the receiver is turned off (step 209) and the process becomes idle (step 210) until another script is run. It should be noted that multiple scripts may be “run” concurrently or in overlapping fashion (i.e., display or recording according to one script is performed while the start time for another script is awaited). By employing scripting rather than merely time and channel based programming, the present invention provides greater control over the identification and selection of broadcast programming to be viewed and/or recorded by the user, particularly in selection of programs based on descriptive criteria. For example, rather than having to be aware of any potential timing conflicts between concurrently airing programs each matching a different descriptive criterion, the user may simply specify priorities, at the time the script(s) are created, for resolving such conflicts when they arise. Similarly, the user may set conditions at the time the scripts are created on when or how matches are selected or presented for viewing or recording. Existing program selection control techniques do not provide such flexibility, and therefore do not allow effective extension or customization of the firmware in the manner of the present invention.

Those skilled in the art will recognize that the functionality of the present invention need not be limited to embodiment within a video receiver alone, but may be implemented in whole or in part within related devices, such as a remote control device for the video receiver. The video receiver and remote control device may operate collaboratively, such as by retrieval of program guide information through the video receiver for transfer to the remote control device.

It is important to note that while the present invention has been described in the context of a fully functional video receiver, those skilled in the art will appreciate that at least portions of the mechanism of the present invention is capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A system for extending unattended control capabilities for a video receiver comprising:
a shell for executing scripts controlling demodulation of broadcast programming; and
a memory containing at least one script including a sequence of commands for demodulating selected broadcast programming, wherein the at least one script is executable by the shell to select broadcast programming for demodulation from among one or more concurrently airing programs each matching at least one of a plurality of user-specified descriptive criteria, wherein said at least one script employs associated previously-defined user priorities or conditions to select between conflicting matches or routing options.

2. The system as set forth in claim 1 wherein the at least one script identifies the selected broadcast programming by at least one of:
one or more channels on which the selected broadcast programming is to be broadcast and one or more time periods during which the selected broadcast programming is to be broadcast;
a title of the selected broadcast programming; and
keywords describing the selected broadcast programming.

3. The system as set forth in claim 1 wherein the at least one script, when executed by the shell, controls operation of the video receiver to cause a sequence of programs broadcast during separate contiguous time periods on different channels to be demodulated and displayed by the video receiver.

4. The system as set forth in claim 1 wherein the at least one script, when executed by the shell, controls operation of the video receiver to cause the selected broadcast programming to be demodulated and transmitted to a recording device.

5. The system as set forth in claim 4 wherein the at least one script, prior to causing the selected broadcast programming to be demodulated and transmitted to a recording device, checks for previous demodulation and transmission of the selected broadcast programming to the recording device, wherein execution of the at least one script is terminated if the selected broadcast programming was previously demodulated and transmitted to the recording device.

6. The system as set forth in claim 1 wherein the at least one script is received by the video receiver together with a broadcast programming stream including the selected broadcast programming.

7. The system as set forth in claim 1 wherein the at least one script is received by the video receiver from an external source separate from a broadcast programming stream including the selected broadcast programming.

8. A video receiver comprising:
an input for receiving broadcast programming; and
a scripting system for extending unattended control capabilities for the video receiver, the scripting system comprising:
a shell for executing scripts controlling demodulation of broadcast programming; and
a memory containing at least one script including a sequence of commands for demodulating selected broadcast programming, wherein the at least one script is executable by the shell to select broadcast programming for demodulation from among one or more concurrently airing programs each matching at least one of a plurality of user-specified descriptive criteria,wherein said at least one script employs associated previously-defined user priorities or conditions to select between conflicting matches or routing options.

9. The video receiver as set forth in claim 8 wherein the at least one script identifies the selected broadcast programming by one of:
one or more channels on which the selected broadcast programming is to be broadcast and one or more time periods during which the selected broadcast programming is to be broadcast;
a title of the selected broadcast programming; and
keywords describing the selected broadcast programming.

10. The video receiver as set forth in claim 8 wherein the at least one script, when executed by the shell, controls operation of the video receiver to cause a sequence of programs broadcast during separate contiguous time periods on different channels to be demodulated and displayed by the video receiver.

11. The video receiver as set forth in claim 8 wherein the at least one script, when executed by the shell, controls operation of the video receiver to cause the selected broadcast programming to be demodulated and transmitted to a recording device.

12. The video receiver as set forth in claim 11 wherein the at least one script, prior to causing the selected broadcast programming to be demodulated and transmitted to a recording device, checks for previous demodulation and transmission of the selected broadcast programming to the recording device, wherein execution of the at least one script is terminated if the selected broadcast programming was previously demodulated and transmitted to the recording device.

13. The video receiver as set forth in claim 8 wherein the at least one script is received by the video receiver via the input together with a broadcast programming stream including the selected broadcast programming.

14. The video receiver as set forth in claim 8 wherein the at least one script is received by the video receiver from an external source separate from a broadcast programming stream including the selected broadcast programming.

15. A method for extending unattended control capabilities for a video receiver comprising:
executing, using a shell within the video receiver, scripts controlling demodulation of broadcast programming; and
storing, within a memory in the video receiver, at least one script including a sequence of commands for demodulating selected broadcast programming, wherein the at least one script is executable by the shell to select broadcast programming for demodulation from among one or more concurrently airing programs each matching at least one of a plurality of user-specified descriptive criteria, wherein said at least one script employs associated previously-defined user priorities or conditions to select between conflicting matches or routing options.

16. The method as set forth in claim 15 further comprising:
identifying the selected broadcast programming within the at least one script by one of:
one or more channels on which the selected broadcast programming is to be broadcast and one or more time periods during which the selected broadcast programming is to be broadcast;
a title of the selected broadcast programming; and
keywords describing the selected broadcast programming.

17. The method as set forth in claim 15 further comprising:
executing the at least one script utilizing the shell to control operation of the video receiver and cause a sequence of programs broadcast during separate contiguous time periods on different channels to be demodulated and displayed by the video receiver.

18. The method as set forth in claim 15 further comprising:
executing the at least one script utilizing the shell to control operation of the video receiver and cause the selected broadcast programming to be demodulated and transmitted to a recording device.

19. The method as set forth in claim 18 further comprising:
prior to causing the selected broadcast programming to be demodulated and transmitted to a recording device, checking for previous demodulation and transmission of the selected broadcast programming to the recording device, wherein execution of the at least one script is terminated if the selected broadcast programming was previously demodulated and transmitted to the recording device.

20. The method as set forth in claim 15 further comprising:
receiving the at least one script at an input to the video receiver together with a broadcast programming stream including the selected broadcast programming.

21. The method as set forth in claim 15 further comprising:
receiving the at least one script at an input to the video receiver from an external source separate from a broadcast programming stream including the selected broadcast programming.

22. A datastream for use with a video receiver comprising:
a broadcast programming stream including selected broadcast programming; and
at least one script including a sequence of commands for causing the video receiver to demodulate the selected broadcast programming for display or recording, wherein the at least one script is executable by a shell running within the video receiver.
